(19) United States
(12) Patent Application Publication
(10) Pub. No.: US 2007/0171500 A1
(43) Pub. Date: Jul. 26, 2007

(54) Micro mirror employing piezo actuator

(75) Inventors: Hee-moon Jeong, Yongin-si (KR); Jun-o Kim, Yongin-si (KR); Hwa-sun Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/472,321

(22) Filed: Jun. 22, 2006

(30) Foreign Application Priority Data
Jan. 25, 2006 (KR) 10-2006-0007908

(51) Int. Cl. G02B 26/08

(52) U.S. Cl. 359/224

(57) ABSTRACT

A micro device and a micro mirror employing a piezo actuator are provided. The micro mirror includes a substrate; a plate which is rotatably suspended about a rotation axis over the substrate; at least two cantilevers, each comprising a fixed end fixed to the substrate, and a free end perpendicularly crossing the rotation axis of the plate and connecting to a side of the plate, each cantilever having a piezo actuator installed on an upper surface of the cantilever; a plurality of connectors each one of which connects the free end of a corresponding one of the cantilevers to a side of the plate; and a pair of torsion springs which are connected to the plate and act as a rotational axis for the plate.

### CROSS-REFERENCE TO RELATED APPLICATION

This application claims priority from Korean Patent Application No. 10-2006-0007908, filed on Jan. 25, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a micro device, and more particularly, to a high efficient micro mirror employing a piezo actuator.

2. Description of the Related Art

A micro mirror manufactured using a micro-electro mechanical system (MEMS) technique is used as a light scanner for scanning laser beams in horizontal and vertical directions in a laser TV. Various driving apparatuses for driving a micro mirror in horizontal or/and vertical directions have been suggested.

FIG. 1 is a cross-sectional view of a conventional micro mirror 10 having a piezo actuator. Referring to FIG. 1, the conventional micro mirror 10 includes an elastic substrate 11 having opposite ends fixed by fixed portions 16, a lower electrode 12 formed on an upper surface of the elastic substrate 11, two piezo elements 13a and 13b formed on an upper surface of the lower electrode 12 and upper electrodes 14a and 14b formed on the two piezo elements 13a and 13b, respectively. The two piezo elements 13a and 13b are arranged to have opposite polarization directions. The two piezo elements 13a and 13b and the lower and upper electrodes 12, 14a, and 14b form two piezo actuators. A mirror 15 is formed between the two piezo elements 13a and 13b.

As commonly known, a piezo element, for example, a PZT, is polarized in a specific direction by poling a ferroelectric material, and the piezo element contracts/expands with respect to the applied voltage direction. Accordingly, when voltage is applied to the lower electrode 12 and the upper electrodes 14a and 14b, one of the two piezo elements 13a and 13b expands and the other contracts. For example, as illustrated in FIG. 2, the piezo element 13a disposed on the left side of FIG. 2 contracts, and the piezo element 13b disposed on the right side of FIG. 2 expands. Then, the portion of the elastic substrate 11 disposed under the contracted piezo element 13a is upwardly bent, and the portion of the elastic substrate 11 disposed under the expanded piezo element 13b is downwardly bent. Accordingly, the mirror 15 disposed between the two piezo elements 13a and 13b rotates in a clockwise direction about a rotation axis 16. In addition, when the applied voltage direction is reversed, the mirror 15 rotates in a counter-clockwise direction about the rotation axis 16. Therefore, the conventional micro mirror 10 can be driven using the piezo actuator.

However, in the case of the above-described conventional micro mirror 10, the elastic substrate 11 is greatly deformed during operation, as illustrated in FIG. 2, and thus the efficiency of the piezo actuator is low. To improve the efficiency of the piezo actuator, the elastic substrate 11 is separated from the mirror 15 and a connector, which can be distorted, may be disposed between the elastic substrate 11 and the mirror 15. However, the inclined direction of the mirror 15, which is indicated by a line A in FIG. 2, is reverse with respect to the inclined direction of the elastic substrate 11, which is indicated by a line B in FIG. 2. That is, since the rotation directions of the mirrors and the elastic substrate 11 are opposite to each other, and thus when manufacturing the micro mirror 10, it is difficult to generate all deformation only at the connector. Accordingly, in this case, the deformation is generated at the connector between the elastic substrate 11 and the mirror 15 and at the elastic substrate 11, thereby degrading the efficiency of the piezo actuator. Accordingly, the driving efficiency of the micro mirror 10 is lower and the voltage consumed increases. In addition, it is difficult to increase the driving angle of the mirror 15.

### SUMMARY OF THE INVENTION

According to an aspect of the present invention, there is provided a micro mirror including a substrate; a plate which is rotatably suspended about a rotation axis over the substrate; at least two cantilevers, each comprising a fixed end fixed to the substrate, and a free end perpendicularly crossing the rotation axis of the plate and connecting to a side of the plate, each cantilever having a piezo actuator installed on an upper surface of the cantilever; a plurality of connectors each one of which connects the free end of a corresponding one of the cantilevers to a side of the plate; and a pair of torsion springs which are connected to the plate and act as a rotational axis for the plate.

The plate may be a reflecting plate.

The cantilevers may be separately fixed to the substrate through cantilever fixing units protruding from the substrate, and may be aligned parallel to the substrate when not driven.

The connectors may be disposed parallel to the rotational axis of the plate.

First ends of the torsion springs may be connected to the rotational centers of the sides of the plate and support the plate to rotate, and second ends of the torsion springs may be separately fixed to the substrate through spring fixing units protruding from the substrate.

The first ends of the torsion springs may be connected to the rotational centers of extending plates, which extend from the free ends of the cantilevers to perpendicularly cross the rotational axis of the plate, and second ends of the torsion springs may be separately fixed to the substrate through spring fixing units protruding from the substrate.

At least one pair of the cantilevers may be installed on opposite sides of the plate.

The fixed ends of two adjacent cantilevers on the same side of the plate may be oppositely disposed to each other about the rotational axis of the plate.

The micro mirror may further include a connecting plate connected to free ends of the two adjacent cantilevers on the same side of the plate.

The connecting plate may perpendicularly cross the rotational axis of the plate.

According to another aspect of the present invention, there is provided a micro mirror including a substrate; a frame which is rotatably suspended about a rotational axis of the frame and disposed over the substrate; a first cantilever which comprises a fixed end fixed to the substrate, and a free end perpendicularly crossing the rotational axis of the frame and connecting to a side of the frame, wherein a piezo actuator is installed on an upper surface of the first cantilever; a first connector connecting the free end of the first cantilever and the side of the frame; a pair of first torsion springs acting as a rotational axis when the frame is driven to rotate; a plate which is rotatably suspended about a rotational axis of the plate inside the frame; a second cantilever which comprises a fixed end fixed to the frame, and a free end perpendicularly crossing the rotational axis of the plate and connecting to a side of the reflecting plate, wherein a piezo actuator is installed on an upper surface of the second cantilever; a second connector connecting the free end of the second cantilever and the side of the plate; and a pair of second torsion springs which are connected to the plate and act as a rotational axis when the plate is driven to rotate.

The rotation axis of the frame may be perpendicular to the rotational axis of the plate.

According to another aspect of the invention, a micro device is provided. The micro device includes a substrate; a plate which is rotatably suspended about a rotation axis over the substrate; at least two cantilevers, each comprising a fixed end fixed to the substrate, and a free end perpendicularly crossing the rotation axis of the plate and connecting to a side of the plate, each cantilever having a piezo actuator installed on an upper surface of the cantilever; a plurality of connectors each one of which connects the free end of a corresponding one of the cantilevers to a side of the plate; and a pair of torsion springs which are connected to the plate and act as a rotational axis for the plate.

### BRIEF DESCRIPTION OF THE DRAWINGS

The above and other aspects of the present invention will become more apparent by describing in detail exemplary embodiments thereof with reference to the attached drawings in which:

FIG. 1 is a cross-sectional view of a conventional micro mirror having a piezo actuator;

FIG. 2 is a cross-sectional view of the conventional micro mirror of FIG. 1 during an operation thereof;

FIG. 3 is a perspective view of a micro mirror having a piezo actuator, according to an exemplary embodiment of the present invention;

FIGS. 4A and 4B illustrate simplified models of a micro mirror according to an exemplary embodiment of the present invention and a conventional micro mirror, respectively, in order to substantially analyze efficiency enhancement using a simulation method;

FIG. 5 is a graph illustrating a comparison of moments required for the micro mirror of FIG. 4A and the conventional micro mirror of FIG. 4B;

FIGS. 6A and 6B are graphs illustrating differences in operation states of the micro mirror of FIG. 4A and the micro mirror of FIG. 4B;

FIG. 7 is a plan view illustrating the configuration of a micro mirror according to another exemplary embodiment of the present invention;

FIGS. 8A through 8C are plan views of single-axis micro mirrors employing a plurality of piezo actuators, according to exemplary embodiments of the present invention; and

FIGS. 9A through 9C are plan views of two-axis micro mirrors employing a plurality of piezo actuators, according to exemplary embodiments of the present invention.

### DETAILED DESCRIPTION OF EXEMPLARY EMBODIMENTS OF THE PRESENT INVENTION

Hereinafter, exemplary embodiments of the present invention will be described more fully with reference to the accompanying drawings, in which exemplary embodiments of the invention are shown. While illustrative, non-limiting, exemplary embodiments are described with reference to a micro mirror, one skilled in the art will understand that the overall concept of the invention is applicable to any micro device which involves rotation of a plate on a substrate.

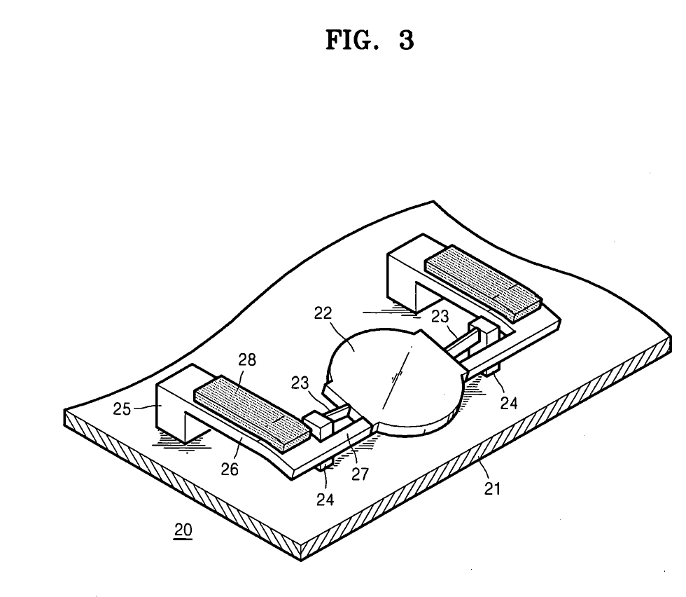

FIG. 3 is a perspective view of a micro mirror 20 having a piezo actuator, according to an exemplary embodiment of the present invention. Referring to FIG. 3, in the micro mirror 20, a reflecting plate 22 reflecting light is rotatably suspended by a pair of torsion springs 23 on a substrate 21 of the micro mirror 20, and both sides of the reflecting plate 22 are connected to a pair of cantilevers 26 through connectors 27.

First ends of the torsion springs 23 are connected to a rotation center of the reflecting plate 22, and second ends of the torsion springs 23 are separately fixed to the substrate 21 through spring fixing units 24 protruding from the substrate 21. Accordingly, the torsion springs 23 act as a rotation axis when the reflecting plate 22 rotates.

First ends of the cantilevers 26 are fixed ends, and are separately fixed to the substrate 21 through cantilever fixing units 25 protruding from the substrate 21. The cantilevers 26 and the torsion springs 23 are parallel to the substrate 21 in a non-operating state. Second ends of the cantilevers 26 are free ends, and perpendicularly cross a virtual rotation axis extending from the rotation center of the reflecting plate 22. The connectors 27 connect the sides of the reflecting plate 22 and the cantilevers 26, and may be aligned parallel to the rotation axis of the reflecting plate 22. Piezo actuators 28 driving the rotation of the reflecting plate 22 are installed on upper surfaces of the cantilevers 26. As commonly known, the piezo actuators 28 have a structure in which electrodes are formed on upper and lower sides of a piezo element, for example, a PZT.

In the micro mirror 20 of this exemplary embodiment, a principle that the piezo elements contract/expand according to the voltage direction applied to the piezo actuators 28 is employed. For example, when the piezo elements of the piezo actuators 28 disposed on both sides of the reflecting plates 22 contract, the cantilevers 26 disposed on both sides of the reflecting plate 22 are upwardly bent. Accordingly, the reflecting plate 22 rotates in a counter-clockwise direction about the torsion springs 23 from the viewpoint of FIG. 3. When a voltage is applied in the opposite direction, the piezo elements expand, and the cantilevers 26 disposed on both sides of the reflecting plate 22 are downwardly bent. Accordingly, the reflecting plate 22 rotates in a clockwise direction about the torsion springs 23. Thus, when the direction of the voltage is periodically changed, the reflecting plate 22 can rotate periodically about the torsion springs 23.

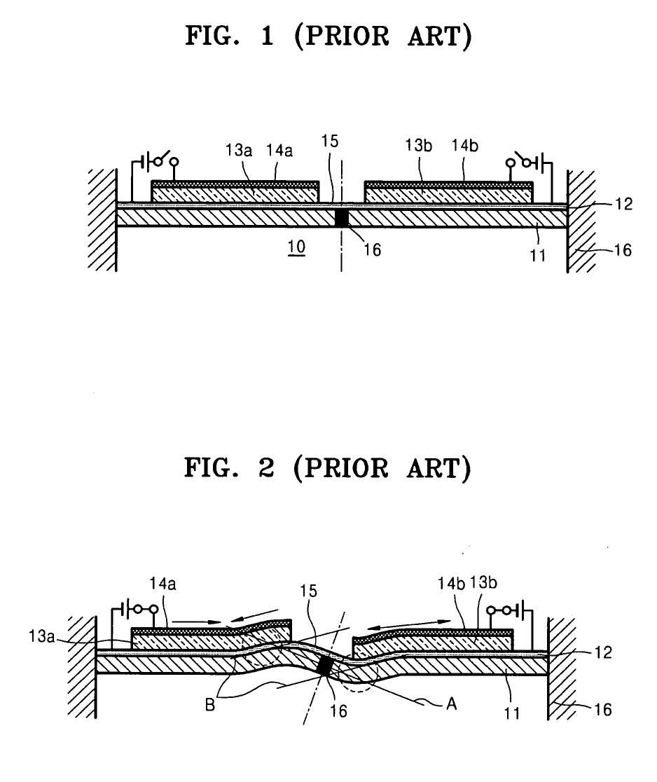

Unlike the conventional micro mirror 10 illustrated in FIGS. 1 and 2, the cantilevers 26 cross the rotation axis of the reflecting plate 22 to connect to a side of the reflecting plate 22 through the connectors 27, and thus the inclined direction and angle of the cantilevers 26 is the same as the rotation direction and angle of the reflecting plate 22. Accordingly, the cantilevers 26 are seldom deformed during the driving, of the micro mirror 20. In a conventional micro mirror, the inclined direction of the cantilever is opposite to the rotation direction of the reflecting plate, and thus the deformation of the cantilever causes a reduction in efficiency. However, in the micro mirror 20 according to this exemplary embodiment of the present invention, since the cantilevers 26 are seldom deformed, the micro mirror 20 according to this exemplary embodiment can provide high efficiency. In this exemplary embodiment, only the torsion springs 23 and the connectors 27 are distorted. Accordingly, a greater driving angle can be obtained using a lower driving force, and thus voltage consumption can be reduced.

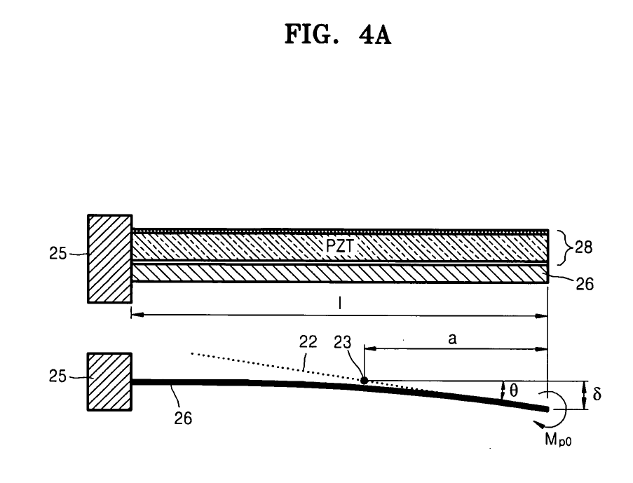

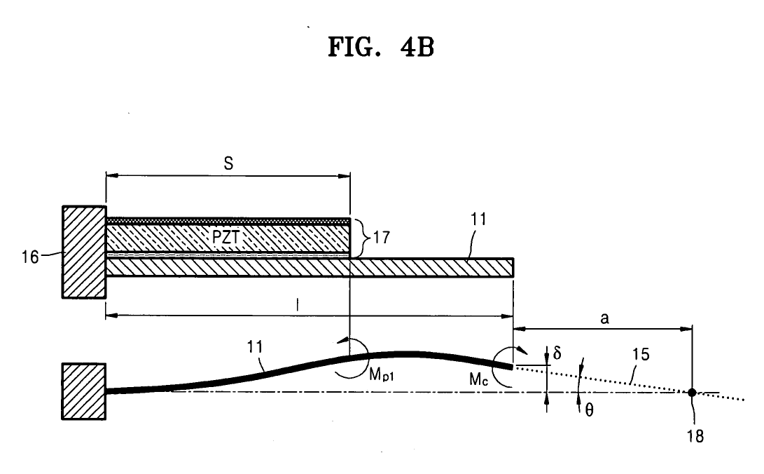

FIGS. 4A and 4B illustrate simplified models of a micro mirror according to an exemplary embodiment of the present invention and a conventional micro mirror, respectively, in order to substantially analyze efficiency enhancement using a simulation method. In the simulation model of the micro mirror illustrated in FIG. 4A, a cantilever 26 and a piezo actuator have the same length “1”. A rotation axis 23 of a reflecting plate 22 is situated inside the cantilever 26, and the distance between the rotation axis 23 of the reflecting plate 22 and a free end of the cantilever 26 is “a”. In addition, θ denotes a rotation angle of the reflecting plate 22, δ denotes a vertical displacement of the free end of the cantilever 26, and Mₚ₀ denotes a moment required for the displacement. In the conventional micro mirror illustrated in FIG. 4B, the length of an elastic substrate 11 is “1”, and the length of a piezo actuator 17 is “s”. In addition, a rotation axis 18 of the mirror 15 is situated outside the elastic substrate 11. In order to analyze the conventional micro mirror under the same conditions as used for the model according to the present exemplary embodiment, it is assumed that the distance between the rotation axis 18 of the mirror 15 and a free end of the elastic substrate 11 is “a”, the mirror 15 rotates by an angle “θ”, and the free end of the elastic substrate 11 is displaced by a vertical displacement “δ”. Mₚ₁ denotes a moment required for the displacement. M_{c} denotes a moment caused by external contraction conditions of the elastic substrate 11.

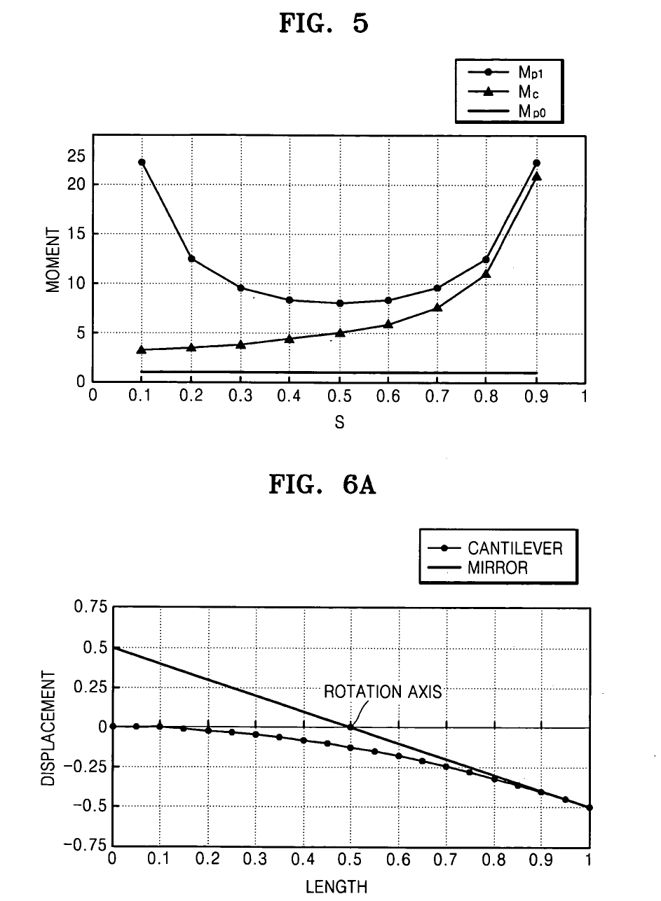

FIG. 5 is a graph illustrating a comparison of moments required for the micro mirror of FIG. 4A and the conventional micro mirror of FIG. 4B . In FIG. 5, l=1 and Mₚ₀=1 are defined for convenience of comparison. In the case of the conventional micro mirror, the length s of the piezo actuator 17 is changed from 0.1 to 0.9 to obtain an optimized condition. As illustrated in FIG. 5, the conventional micro mirror is optimized when s=0.5. However, in the case of the conventional micro mirror, the required moment Mₚ₁ equals 8 at the optimized condition. Accordingly, the micro mirror of the current exemplary embodiment of the present invention requires a driving force ⅛ times that required for the conventional micro mirror to generate the same rotation angle.

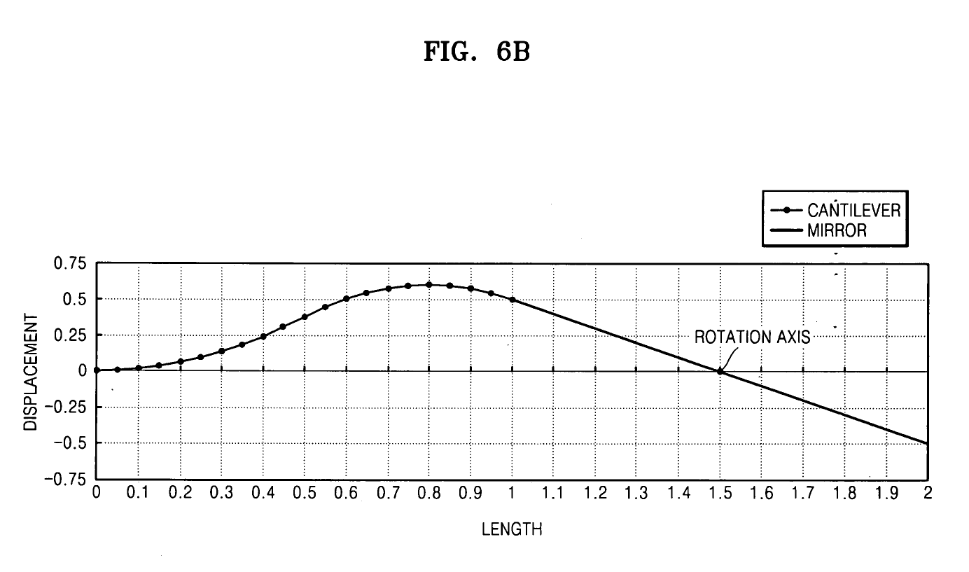

FIGS. 6A and 6B are graphs illustrating differences in operation states of the micro mirror of FIG. 4A and the conventional micro mirror of FIG. 4B. Referring to FIG. 6A, in the model of the micro mirror according to an exemplary embodiment of the present invention, which is illustrated in FIG. 4A, the cantilever 26 is bent due to the driving of the piezo actuator, but other deformations of the cantilever 26 are not shown. The inclination angle of the free end of the cantilever 26 is almost the same as the rotation angle of the micro mirror. Referring to FIG. 6B, in the conventional micro mirror of FIG. 4B, the cantilever is bent due to the driving of the piezo actuator 17 and further deformed. That is, an inflection is generated near the free end of the cantilever. This inflection is caused due to the rotational direction of the cantilever being opposite to the rotational direction of the micro mirror. Since additional energy is consumed due to the deformation, the conventional micro mirror needs more driving force than the micro mirror according to an exemplary embodiment of the present invention to obtain the same driving angle. In addition, in this exemplary embodiment, the inclination angle of the free end of the cantilever 26 is the same as the rotation angle of the mirror 22, and thus the rotation angle of the mirror 22 can be easily controlled compared with the conventional micro mirror.

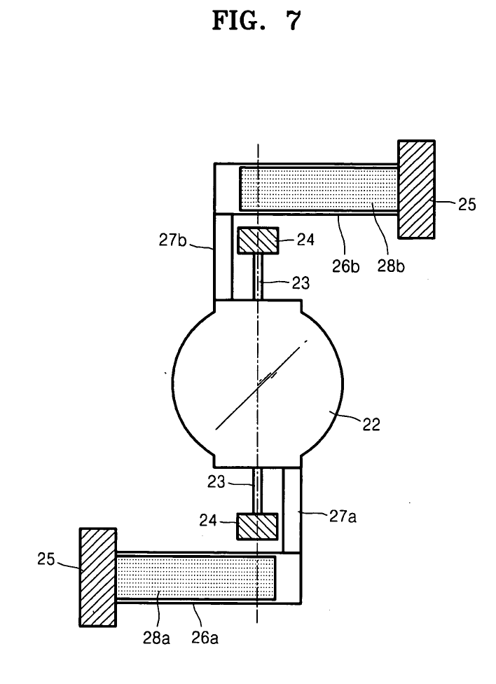

FIG. 7 is a plan view illustrating the configuration of a micro mirror according to another exemplary embodiment of the present invention. A substrate is not illustrated in FIG. 7 for convenience of explanation, and a shaded portion denotes a portion fixed to the substrate. In the micro mirror of FIG. 7, first and second cantilevers 26a and 26b are disposed in opposite directions to each other. In the micro mirror of FIG. 3, the fixed ends and free ends of the cantilevers 26 are disposed in the same direction. However, in the micro mirror of FIG. 7, the free ends and fixed ends of the first and second cantilevers 26a and 26b are disposed in opposite directions about a rotation axis of a reflecting plate 22. In this structure, the first and second cantilevers 26a and 26b are bent in opposite directions. For example, when the first cantilever 26a is bent upwards, the second cantilever 26b is bent downwards. Then, the right side of the reflecting plate 22 as viewed in FIG. 7 rises and the left side of the reflecting plate 22 falls. For this, a first piezo actuator 28a disposed on an upper surface of the first cantilever 26a is controlled to contract, and a second piezo actuator 28b disposed on an upper surface of the second cantilever 26b is controlled to expand.

In the above-described exemplary embodiments, only one pair of first and second cantilevers 26a and 26b are connected to both sides of the reflecting plate 22, but several pairs of cantilevers may be connected in order to increase driving force.

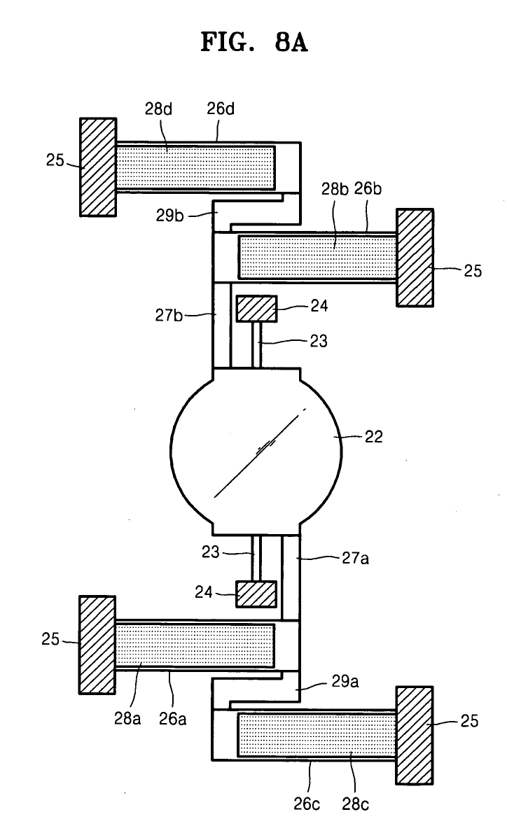

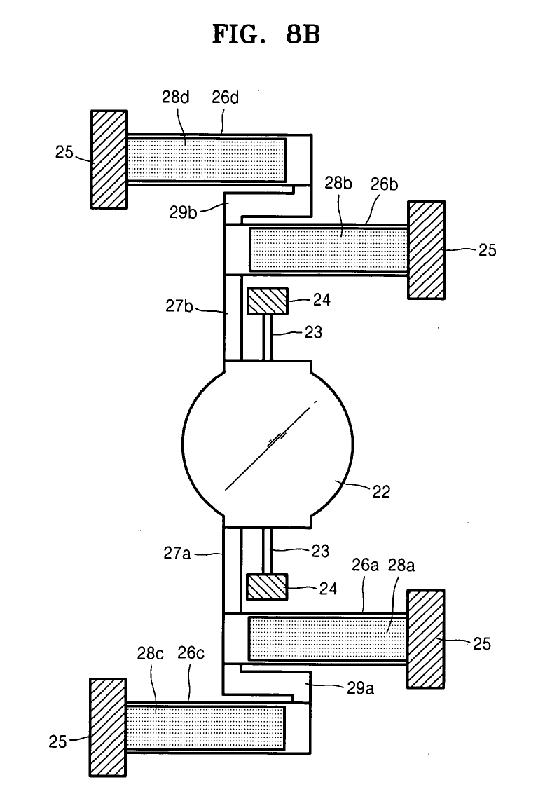

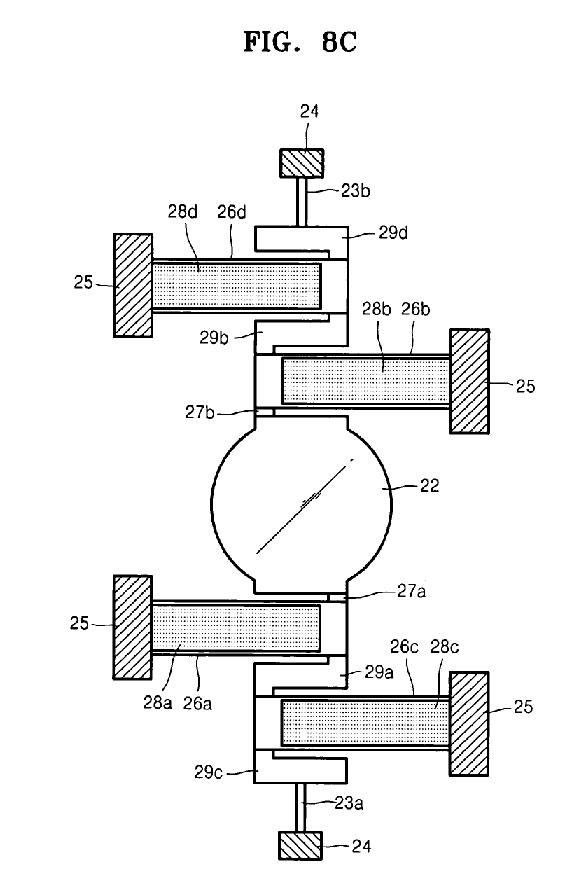

FIG. 8A illustrates a single-axis micro-mirror in which a pair of first and second cantilevers 26a and 26b, and a pair of third and fourth cantilevers 26c and 26d are connected to a reflecting plate 22, according to an exemplary embodiment of the present invention. In FIG. 8A, the third and fourth cantilevers 26c and 26d are connected to the first and second cantilevers 26a and 26b, respectively. According to an exemplary embodiment of the present invention, fixed ends and free ends of two cantilevers adjacent to each other on the same side of the reflecting plate 22 may be disposed in opposite directions about a rotation axis of the reflecting plate 22. For example, fixed ends of the first cantilever 26a and the third cantilever 26c are disposed in opposite directions to each other, Fixed, ends of the second cantilever 26b and the fourth cantilever 26d are also disposed in opposite directions to each other. Accordingly, since the first through fourth cantilevers 26a, 26b, 26c, and 26d are symmetrically arranged about the rotation axis of the reflecting plate 22, a stable rotational driving force can be obtained. In order to transfer a driving force of the outermost cantilevers, which are the third and fourth cantilevers 26c and 26d, to the reflecting plate 22, a connecting plate is connected between free ends of cantilevers adjacent to each other on the same side of the reflecting plate 22. For example, a first connecting plate 29a is connected between the free ends of the first cantilever 26a and the third cantilever 26c, and a second connecting plate 29b is connected between the free ends of the second cantilever 26b and fourth cantilever 26d. The first and second connecting plates 29a and 29b are disposed perpendicular to the rotation axis of the reflecting plate 22.

In this structure, the first and fourth cantilevers 26a and 26d are bent in the same direction as each other, and the second and third cantilevers 26b and 26c are bent in the same direction as each other, but opposite to the direction in which the first and fourth cantilevers 26a and 26d are bent. For example, when the first and fourth cantilever 26a and 26d are simultaneously bent upwards, the second and third cantilevers 26b and 26c are simultaneously bent downwards. Accordingly, as viewed in FIG. 8A, the right side of the reflecting plate 22 rises and the left side thereof falls. That is, the reflecting plate 22 rotates. The first and second connecting plates 29a and 29b also rotate according to the, rotation of the reflecting plate 22 and maintain the same plane.

FIG. 8B illustrates a single-axis micro-mirror in which a pair of third and fourth cantilevers 26c and 26d are connected to a pair of first and second cantilevers 26a and 26b, according to an exemplary embodiment of the present invention. In FIG. 8B, unlike the exemplary embodiment of FIG. 8A, fixed ends and free ends of the first and second cantilevers 26a and 26b are disposed in the same direction about a rotation axis of a reflecting plate 22, and fixed ends and free ends of the third and fourth cantilevers 26c and 26d are disposed in the opposite direction to the first and second cantilevers 26a and 26b about the rotation axis of the reflecting plate 22. Besides this, the exemplary embodiment of FIG. 8B has the same structure and performs the same operation as the exemplary embodiment of FIG. 8A.

Meanwhile, FIG. 8C illustrates a single-axis micro-mirror in which first and second torsion springs 23a and 23b acting as a rotation axis of a reflecting plate 22 are not directly connected to the reflecting plate 22, but are indirectly connected thereto via outer third and fourth cantilevers 26c and 26d, according to an exemplary embodiment of the present invention. For example, a first end of the first torsion spring 23a is connected to a first extending plate 29c extending from a free end of the third cantilever 26c, and a second end thereof is separately fixed to a substrate through a spring fixing unit 24. In order to change a vertical motion of the cantilevers to a rotational motion, a first extending plate 29c is bent from a free end of the third cantilever 26c and extends to perpendicularly cross the rotation axis of the reflecting plate 22. In addition, the first torsion spring 23a is connected to a rotational center of the first extending plate 29c. Similarly, a first end of the second torsion spring 23b is connected to a rotational center of a second extending plate 29d which is bent from a free end of the fourth cantilever 26d to perpendicularly cross the rotational axis of the reflecting plate 22. When manufacturing the micro mirror according to this exemplary embodiment of the present invention, structural elements such as the reflecting plate 22, the first through fourth cantilevers 26a, 26b, 26c, and 26d, the first and second connecting plates 29a and 29b, the first and second connectors 27a and 27b, the first and second torsion springs 23a and 23b, and the first and second extending plates 29c and 29d are integrally formed with each other by etching one material. Accordingly, although the first and second torsion springs 23a and 23b acting as the rotational axis of the reflecting plate 22 are not directly connected to the reflecting plate 22, but are indirectly connected through the third and fourth cantilevers 26c and 26d, the reflecting plate 22 stably rotates about the rotational axis.

Exemplary embodiments in which a reflecting plate rotates about a single axis have been described. However, in order to use a micro mirror as a light scanner in a laser TV, a reflecting plate should rotate about two axes which are perpendicular to each other, since to form an image on a two-dimensional screen, the light scanner should scan laser beams in both vertical and horizontal directions.

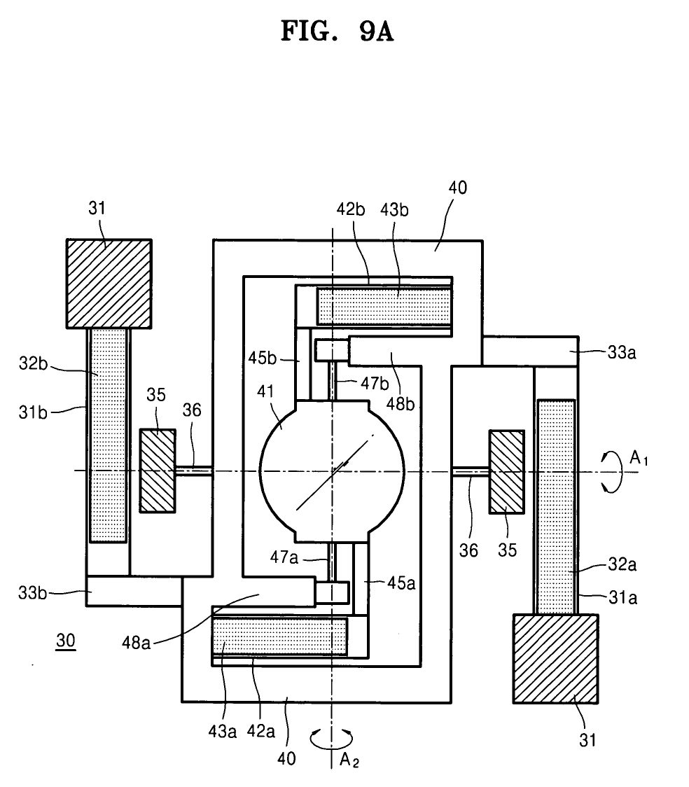

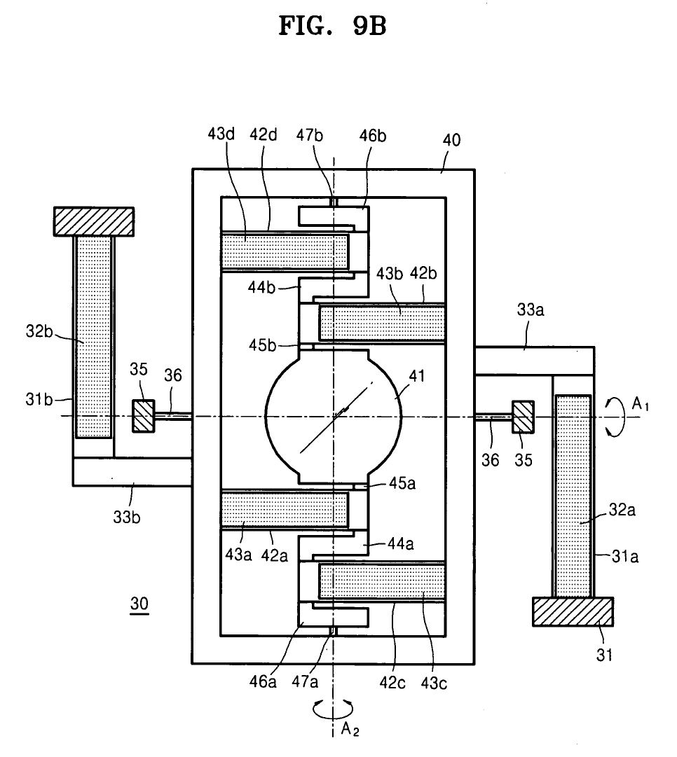

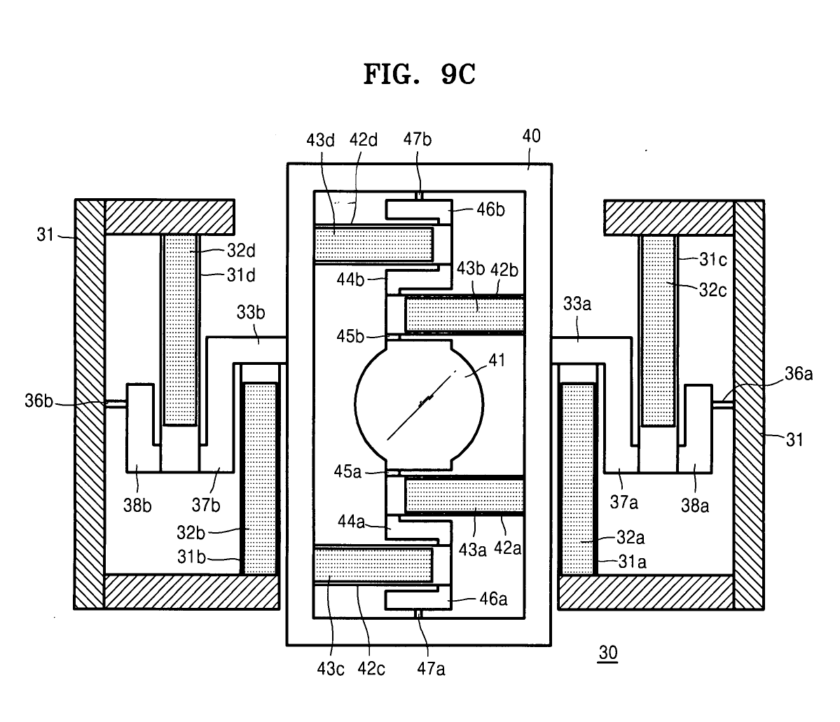

FIGS. 9A through 9C are plan views of two-axis micro mirrors employing a plurality of piezo actuators, according to exemplary embodiments of the present invention. Hereinafter, referring to FIGS. 9A through 9C, a two-axis micro mirror 30 using the above-described principle will be described.

Referring to FIG. 9A, in the two-axis micro mirror 30, a frame 40 rotating about an axis A1 is suspended on a substrate (not illustrated), a pair of first cantilevers 31a and 31b are respectively connected to opposite sides of the frame 40 through first connectors 33a and 33b, respectively. First ends of the first cantilevers 31a and 31b are fixed ends which are separately fixed to the substrate through cantilever fixing units 31 protruding from the substrate. Second ends of the first cantilevers 31a and 31b are free ends which perpendicularly cross a rotation axis A1 of the frame 40 and are respectively connected to opposite sides of the frame 40. In addition, first piezo actuators 32a and 32b rotationally driving the frame 40 are respectively installed on upper surfaces of the first cantilevers 31a and 31b. Meanwhile, first ends of a pair of first torsion springs 36 acting as a rotational axis of the frame 40 are connected to the rotation center of the frame 40. Second ends of the first torsion springs 36 are separately fixed to the substrate through fixing units 35 protruding from the substrate. Accordingly, the two-axis micro mirror 30 of FIG. 9A has the same structure as the micro mirror of FIG. 7, when the reflecting plate 22 of the micro mirror is substituted by the frame 40.

To drive in two axes, a reflecting plate 41 rotating around an axis A2 which is perpendicular to the axis A1 is suspended in the frame 40. A pair of second cantilevers 42a and 42b are respectively connected to opposite sides of the reflecting plate 41 through second connectors 45a and 45b. First ends of the second cantilevers 42a and 42b are fixed ends fixed to the frame 40. As illustrated in FIG. 9A, the fixed ends of the two second cantilevers 42a and 42b are disposed in the frame 40 in opposite directions to each other about the axis A2. Second ends of the second cantilevers 42a and 42b are free ends which perpendicularly cross the rotation axis A2 of the reflecting plate 41 and are respectively connected to opposite sides of the reflecting plate 41. Second piezo actuators 43a and 43b rotationally driving the reflecting plate 41 are respectively installed on upper surfaces of the second cantilevers 42a and 42b. In addition, first ends of a pair of second torsion springs 47a and 47b acting as a rotational axis of the reflecting plate 41 are connected to the rotational center A2 of the reflecting plate 41. Second ends of the second torsion springs 47a and 47b are fixed to spring fixing units 48a and 48b perpendicular protruding from the frame 40.

In the above-described two-axis micro mirror 30, when the first cantilevers 31a and 31b are bent in opposite directions to each other, the frame 40 rotates about the axis A1. Accordingly, the reflecting plate 41 suspended in the frame 40 also rotates about the axis A1. At the same time, the second cantilevers 42a and 42b are bent in opposite directions to each other in the frame 40, and the reflecting plate 41 connected to the second cantilevers 42a and 42b rotates about the axis A2. Accordingly, the reflecting plate 41 can rotate about two perpendicular axes, that is the axis A1 and the axis A2.

A two-axis micro mirror 30 of FIG. 9B has a modified frame structure from the two-axis micro mirror 30 of FIG. 9A. A structure in which a frame 40 rotates about an axis A1 is the same as the structure of FIG. 9A. An inner structure of the frame 40 in which a reflecting plate 41 rotates about an axis A2 is the same as the structure of the micro mirror of FIG. 8C. Referring to FIG. 9B, two pairs of cantilevers 42a, 42b, 42c, and 42d are respectively connected to opposite sides of the reflecting plate 41. Fixed ends and free ends of two adjacent cantilevers on the same side of the reflecting plate 41 are disposed in opposite directions to each other about the rotation axis A2 of the reflecting plate 41. In addition, connecting plates 44a and 44b are respectively connected between the free ends of adjacent cantilevers on the same side of the reflecting plate 41. As described above, connecting plates 44a and 44b are arranged to perpendicularly cross the rotational axis A2 of the reflecting plate 41. Second torsion springs 47a and 47b are not directly connected to the reflecting plate 41, but are connected between the outer third and fourth cantilevers 42c and 42d and the frame 40. For example, a first end of the second torsion spring 47a is connected to an extending plate 46a extending from the free end of the third cantilever 42c, and a second end of the second torsion spring 47a is connected to the frame 40. The extending plate 46a is bent from the free end of the cantilever 42c and extends to perpendicularly cross the rotation axis A2 of the reflecting plate 41. The second torsion spring 47a is connected to the rotational center of the extending plate 46a.

In a two-axis micro mirror 30 of FIG. 9C, a structure for rotating the frame 40 is a modified frame structure from the two-axis micro mirror of FIG. 9B. An inner structure of a frame 40 is the same as that of FIG. 9B except for positions of the cantilevers 42a and 42c. Referring to FIG. 9C, two pairs of second cantilevers 31a, 31b, 31c, and 31d are respectively connected to opposite sides of the frame 40. Fixed ends and free ends of two adjacent cantilevers on the same side of the frame 40 are disposed in opposite directions to each other about a rotational axis of the frame 40. In addition, connecting plates 37a and 37b are respectively connected between the free ends of adjacent cantilevers on the same side of the frame 40. First torsion springs 36a and 36b are not directly connected to the frame 40, but are connected between outer first cantilevers 31c and 31d and fixing units 31 through extending plates 38a and 38b. For example, a first end of the first torsion spring 36a is connected to an extending plate 38a extending from the free end of the first cantilever 31c, and a second end of the first torsion spring 36a is connected to the fixing unit 31. The extending plate 38a is bent from the free end of the first cantilever 31c and extends to perpendicularly cross the rotational axis of the frame 40. According to this exemplary embodiment, as illustrated in FIG. 9C, second ends of the first torsion springs 36a and 36b and fixed ends of the first cantilevers 31a, 31b, 31c, and 31d can be fixed using a fixing unit 31 protruding from the substrate.

As described above, in an exemplary embodiment of the present invention, a cantilever crosses a rotational axis of a reflecting plate to connect to a side of the reflecting plate, and thus the inclination direction and angle of the cantilever is the same as the rotational direction and angle of the reflecting plate, respectively. Accordingly, the cantilever is seldom deformed during the driving of a micro mirror, and the micro mirror according to an exemplary embodiment of the present invention provides high efficiency compared with the conventional art. Accordingly, a large driving angle can be obtained by low driving force compared with the conventional art. In an exemplary embodiment of the present invention, the inclination angle of the free end of the cantilever is the same as the rotational angle of the mirror, and thus the rotational angle of the mirror can be easily controlled compared with a conventional mirror.

While the present invention has been particularly shown and described with reference to certain exemplary embodiments thereof, it will be understood by those of ordinary skill in the art that various changes in form and details may be made therein without departing from the spirit and scope of the present invention as defined by the following claims. Particularly, while certain exemplary embodiments have been shown illustrating micro mirrors, one skilled in the art will understand that the principles disclosed relate to a broader array of micro devices which require the rotation of a plate on a substrate.

What is claimed is:

1. A micro mirror comprising:
a substrate;
a reflecting plate which is rotatably suspended about a rotation axis over the substrate;
at least two cantilevers, each comprising a fixed end fixed to the substrate, and a free end perpendicularly crossing the rotation axis of the reflecting plate and connecting to a side of the reflecting plate, each cantilever having a piezo actuator installed on an upper surface of the cantilever;
a plurality of connectors each one of which connects the free end of a corresponding one of the cantilevers to a side of the reflecting plate; and
a pair of torsion springs which are connected to the reflecting plate and act as a rotational axis for the plate.

2. The micro mirror of claim 1, wherein the fixed end of each of the cantilevers are separately fixed to the substrate through a corresponding one of at least two cantilever fixing units protruding from the substrate, and are aligned parallel to the substrate when not driven.

3. The micro mirror of claim 1, wherein the each of the plurality of connectors is disposed parallel to the rotational axis of the reflecting plate.

4. The micro mirror of claim 1, wherein a first end of each of the pair of torsion springs is connected to a rotational center of the side of the reflecting plate, and a second end of each of the pair of torsion springs is separately fixed to the substrate through one of a pair of spring fixing units protruding from the substrate, such that the pair of torsion springs support the reflecting plate while allowing the reflecting plate to rotate.

5. The micro mirror of claim 1, wherein a first end of each of the pair of torsion springs is connected to a rotational center of an extending plate, which extends from the free end of a corresponding one of the cantilevers to perpendicularly cross the rotational axis of the reflecting plate, and a second end of each of the pair of torsion springs is separately fixed to the substrate through one of a pair of spring fixing units protruding from the substrate.

6. The micro mirror of claim 1, wherein at least two of the cantilevers are installed on opposite sides of the reflecting plate.

7. The micro mirror of claim 6, wherein at least two of the cantilevers are installed on a same side of the reflecting plate.

8. The micro mirror of claim 6, wherein fixed ends of two adjacent cantilevers on the same side of the reflecting plate are oppositely disposed to each other about the rotational axis of the reflecting plate.

9. The micro mirror of claim 8, further comprising a connecting plate connected to the free ends of the two adjacent cantilevers on the same side of the reflecting plate.

10. The micro mirror of claim 9, wherein the connecting plate perpendicularly crosses the rotational axis of the reflecting plate.

11. A micro mirror comprising:
a substrate;
a frame which is rotatably suspended about a rotational axis of the frame and disposed over the substrate;
a first cantilever which comprises a fixed end fixed to the substrate, and a free end perpendicularly crossing the rotational axis of the frame and connecting to a side of the frame, wherein a piezo actuator is installed on an upper surface of the first cantilever;
a first connector connecting the free end of the first cantilever and the side of the frame;
a pair of first torsion springs acting as a rotational axis when the frame is driven to rotate;
a reflecting plate which is rotatably suspended about a rotational axis of the reflecting plate inside the frame;
a second cantilever which comprises a fixed end fixed to the frame, and a free end perpendicularly crossing the rotational axis of the reflecting plate and connecting to a side, of the reflecting plate, wherein a piezo actuator is installed on an upper surface of the second cantilever;
a second connector connecting the free end of the second cantilever and the side of the reflecting plate; and
a pair of second torsion springs which are connected to the reflecting plate and act as a rotational axis when the reflecting plate is driven to rotate.

12. The micro mirror of claim 11, wherein the first cantilever is separately fixed to the substrate through a fixing unit protruding from the substrate, and is aligned parallel to the substrate when not driven.

13. The micro mirror of claim 11, wherein a first end of the first torsion spring is connected to a rotational center of the side of the frame, and a second end of the first torsion spring is separately fixed to the substrate through a fixing unit protruding from the substrate, such that the first torsion spring supports the frame to rotate

14. The micro mirror of claim 11, wherein the first end of the first torsion spring is connected to a rotational center of a first extending plate which extends from the free end of the first cantilever to perpendicularly cross the rotational axis of the frame, and the second end of the first torsion spring is separately fixed from the substrate through a fixing unit protruding from the substrate.

15. The micro mirror of claim 11, wherein at least one pair of the first cantilevers are installed in opposite sides of the frame.

16. The micro mirror of claim 15, wherein the fixed ends of the two first adjacent cantilevers on the same side of the frame are oppositely disposed to each other about the rotational axis of the frame.

17. The micro mirror of claim 16, further comprising a first connecting plate connected to free ends of the two first adjacent cantilevers on the same side of the frame.

18. The micro mirror of claim 11, wherein a first end of the second torsion spring is connected to the rotation center of the side of the plate, and a second end of the second torsion spring is fixed to a fixing unit protruding from the frame, such that the second torsion spring supports the reflecting plate to rotate.

19. The micro mirror of claim 11, wherein the first end of the second torsion spring is connected to a rotational center of a second extending plate which extends from the free end of the second cantilever to perpendicularly cross the rotational axis of the reflecting plate, and the second end of the second torsion spring is fixed to the frame.

20. The micro mirror of claim 11, wherein at least one pair of the second cantilevers are installed on opposite sides of the reflecting plate.

21. The micro mirror of claim 20, wherein the fixed ends of the two second adjacent cantilevers on the same side of the reflecting plate are oppositely disposed to each other about the rotational axis of the reflecting plate.

22. The micro mirror of claim 21, further comprising a second connecting plate connected to free ends of the two second adjacent cantilevers on the same side of the reflecting plate.

23. The micro mirror of claim 11, wherein the rotational axis of the frame is perpendicular to the rotational axis of the reflecting plate.

24. A micro device comprising:
a substrate;
a plate which is rotatably suspended about a rotation axis over the substrate;
at least two cantilevers, each comprising a fixed end fixed to the substrate, and a free end perpendicularly crossing the rotation axis of the plate and connecting to a side of the plate, each cantilever having a piezo actuator installed on an upper surface of the cantilever;
a plurality of connectors each one of which connects the free end of a corresponding one of the cantilevers to a side of the plate; and
a pair of torsion springs which are connected to the plate and act as a rotational axis for the plate.

25. The micro device of claim 24, wherein the plate is a reflecting plate.

26. The micro device of claim 24, wherein the fixed end of each of the cantilevers are separately fixed to the substrate through a corresponding one of at least two cantilever fixing units protruding from the substrate, and are aligned parallel to the substrate when not driven.

27. The micro device of claim 24, wherein the each of the plurality of connectors is disposed parallel to the rotational axis of the plate.

28. The micro device of claim 24, wherein a first end of each of the pair of torsion springs is connected to a rotational center of the side of the plate, and a second end of each of the pair of torsion springs is separately fixed to the substrate through one of a pair of spring fixing units protruding from the substrate, such that the pair of torsion springs support the plate while allowing the plate to rotate.

29. The micro device of claim 26, wherein a first end of each of the pair of torsion springs is connected to a rotational center of an extending plate, which extends from the free end of a corresponding one of the cantilevers to perpendicularly cross the rotational axis of the plate, and a second end of each of the pair of torsion springs is separately fixed to the substrate through one of a pair of spring fixing units protruding from the substrate.

30. The micro device of claim 26, wherein at least two of the cantilevers are installed on opposite sides of the plate.

31. The micro device of claim 30, wherein at least two of the cantilevers are installed on a same side of the plate.

32. The micro device of claim 30, wherein fixed ends of two adjacent cantilevers on the same side of the plate are oppositely disposed to each other about the rotational axis of the plate.

33. The micro device of claim 32, further comprising a connecting plate connected to the free ends of the two adjacent cantilevers on the same side of the plate.

34. The micro device of claim 33, wherein the connecting plate perpendicularly crosses the rotational axis of the plate.
